(19) United States
(12) Patent Application Publication
(10) Pub. No.: US 2025/0361862 A1
(43) Pub. Date: Nov. 27, 2025

(54) Swivel Angle Measuring Device on a Hydrostatic Axial Piston Machine with Variable Stroke Volume

(71) Applicant: Robert Bosch GmbH, Stuttgart (DE)

(72) Inventors: David Haenle, Neu-Ulm (DE); Steffen Raschendorfer, Bibertal (DE)

(21) Appl. No.: 19/216,291

(22) Filed: May 22, 2025

(30) Foreign Application Priority Data
May 23, 2024 (DE) 10 2024 204 736.8

(51) Int. Cl. F04B 51/00; F04B 1/2078; F04B 49/12; G01B 7/30; G01D 5/14

(52) U.S. Cl. CPC F04B 51/00; F04B 1/2078; F04B 49/12; G01B 7/30; G01D 5/145

(57) ABSTRACT

In a translational swivel angle measuring device designed and configured to indirectly sense a swivel angle of a swashplate or cylinder drum of an axial piston machine, the swivel angle being adjustable by an adjustment piston guided in an adjustment cylinder, the swivel angle measuring device includes a movable encoder and a transducer affixed to the housing. The encoder is formed by two permanent magnets, for example, that may be carried linearly and translationally by the adjustment piston along its movement direction.

This application claims priority under 35 U.S.C. § 119 to application no. DE 10 2024 204 736.8, filed on May 23, 2024 in Germany, the disclosure of which is incorporated herein by reference in its entirety.

The present disclosure relates to the detection of the swivel angle of a hydrostatic axial piston machine with adjustable stroke volume in a swashplate design or in an inclined axis design.

### BACKGROUND

From the prior art, hydrostatic axial piston machines with adjustable stroke volume in a swashplate design are known, the working pistons of which are coupled to a swashplate that is formed on a swivel cradle. In order to be able to adjust the stroke volume of the axial piston machine, the swivel cradle is pivotally mounted in the housing of the axial piston machine.

DE 10 2017 213 457 A1 shows such an axial piston machine, the swivel cradle of which is coupled to an adjustment piston of a hydrostatic adjustment device via a pivot formed with the swivel cradle in one piece and via a sliding block rotatably mounted thereon. The adjustment device has an adjustment cylinder configured as a screw-in installation sleeve in which the adjustment piston is accommodated in sections. The adjustment piston is double acting. The adjustment pressure means is provided by an external adjustment pressure means source.

In such axial piston machines, it is important to detect the swivel angle of the swivel cradle or the cylinder drum for the control and regulation tasks.

Rotary swivel angle measuring devices are known from the prior art.

DE 10 2014 200 566 A1 discloses a rotary swivel angle measuring device positioned on the (non-physical) swivel axis of the swivel cradle. Thus, the swivel angle is sensed directly and without change (without overspeed or reduction). The swivel angle measuring device has a shaft coupled to the swivel cradle via a rotary coupling device and a swivel cradle pin. The coupling device is a leaf spring made of spring steel. The disadvantage of such swivel angle measuring devices is the installation space requirement.

DE 10 2010 045 540 A1 discloses an axial piston machine, the adjustment device of which comprises an adjustment piston to which a rotary swivel angle measuring device is coupled. This has a permanent magnet which is moved along a circular path past a swivel angle transducer having a Hall sensor using a return lever. The return lever engages with its (free) end portion in a receptacle of the adjustment piston.

Furthermore, it is known from the house prior art to have the (free) end portion of the return lever engage with the circumferential groove of the adjustment piston in the aforementioned axial piston machines with an adjustment piston and with a rotary swivel angle measuring device, in which the lever of the swivel cradle also engages. The swivel angle measuring device is inserted into a through-recess of the housing and thus seals the internal space of the axial piston machine in which tank pressure prevails.

The disadvantage of the latter two rotary swivel angle measuring devices and their transmission of a linear/translational adjustment piston movement into a rotary encoder movement is that the (free) end portion of the return lever must always be moved in and out radially to the recess of the adjustment piston. In addition, the transmission of a comparatively wide movement of the adjustment piston (with increasing tendency) can only be converted into small rotational movements of the encoder at the end areas of the adjustment piston travel, wherein there is an increased risk of jamming. Furthermore, it is disadvantageous that the bearing of the return lever and the holder of the encoder magnet require increased installation space in the axial direction of the bearing.

Axial piston machines in bent-axis design are also known from the prior art, the adjustment cylinder of which is designed as a differential cylinder, to the piston rod of which a pin extending transversely to the movement direction of the adjustment piston is attached, which carries a control lens. An end portion of the piston rod extends into a measurement chamber and has an oblique groove, through which rotational swivel angle detection is carried out.

Furthermore, from the subsequently published prior art, a translational swivel angle measuring device with a rod magnet is known, which is carried by a swashplate-type adjustment piston of an axial piston machine.

### SUMMARY

The object of the present disclosure is to avoid the disadvantages of rotary swivel angle detection and to continue to renew the subsequently-published prior art with translational swivel angle measuring device in which the measuring range of the swivel angle measuring device is to be increased. The overall length of the swivel angle measuring device according to the disclosure should be minimized along the movement direction of the adjustment piston.

The disclosed swivel angle measuring device is designed and configured to indirectly detect a swivel angle of a swashplate or cylinder drum of a hydrostatic axial piston machine. The swivel angle is adjustable by means of an adjustment piston guided in an adjustment cylinder, on which the indirect detection of the swivel angle takes place. For this purpose, the disclosed swivel angle measuring device has an encoder movable with the adjustment piston and a transducer affixed to the housing, in particular a Hall sensor. According to the disclosure, the swivel angle measuring device is translational. For this purpose, the encoder is directly or indirectly coupled to the actuator and can be moved in translation along its movement direction. The encoder is formed by two or more preferably bar-shaped permanent magnets.

This avoids the radial movement of the (free) end portion of the return lever into and out of the recess/groove of the adjustment piston, which is necessary with the rotary swivel angle measuring device of the prior art. In particular, the transmission of a comparatively wide movement of the adjustment piston can be converted into an undiminished wide translational or linear movement of the encoder at the end areas of the adjustment piston travel, wherein the risk of jamming remains low. Thanks to the two or more permanent magnets, a holistic optimum of high measuring accuracy and long actuating piston stroke can be achieved.

In an end position of the adjustment piston, in which a return spring of the adjustment piston is maximally relaxed and thus has maximum length, at least one of the permanent magnets is arranged according to the disclosure at least in sections inside a return spring. As a result, the at least two permanent magnets and the return spring overlap in the end position of the adjustment piston. This minimizes the overall length or the installation space of the swivel angle measuring device according to the disclosure along the movement direction.

In a specific space-saving embodiment with nevertheless high measuring accuracy over a measuring range along the movement direction, e.g. of 60 mm, two permanent magnets are provided. It is particularly space-saving if, in the end position of the adjustment piston, one of the two permanent magnets is arranged completely inside the return spring of the adjustment piston. It is also space-saving if, in addition, the other of the two permanent magnets is arranged in sections inside the return spring of the adjustment piston.

In a first principle of the swivel angle measuring device according to the disclosure, the north poles and the south poles of the permanent magnets are arranged in alternating order along the movement direction of the adjustment piston. In the case of the two permanent magnets, the encoder thus has four poles. For this purpose, the two north poles and the two south poles of the two permanent magnets are arranged in alternating order along the movement direction of the adjustment piston. More specifically, either first the north pole and then the south pole of the first permanent magnet and then the north pole and then the south pole of the second permanent magnet, correspondingly, are arranged in a row, or first the south pole and then the north pole of the first permanent magnet and then first the south pole and then the north pole of the second permanent magnet, correspondingly, are arranged in a row.

In a second principle of the swivel angle measuring device according to the disclosure, either the respective north poles or the respective south poles of the permanent magnets point towards each other along the movement direction of the adjustment piston. In the case of the two permanent magnets, the encoder thus has three poles. For this purpose, either the two north poles or the two south poles of the two permanent magnets point towards each other along the movement direction of the adjustment piston. More precisely, either first the north pole and then the south pole of the first permanent magnet and then first the south pole and then the north pole of the second permanent magnet are arranged along the movement direction of the adjustment piston, or first the south pole and then the north pole of the first permanent magnet and then first the north pole and then the south pole of the second permanent magnet are arranged one behind the other.

Each permanent magnet has a main axis which extends through the south pole and through the north pole. In a third principle of the swivel angle measuring device according to the disclosure, the main axes of the permanent magnets are arranged perpendicular to the movement direction of the adjustment piston. In the case of two permanent magnets, the result is that the north pole of the first permanent magnet and the south pole of the second permanent magnet face the transducer, while the south pole of the first permanent magnet and the north pole of the second permanent magnet face away from the transducer, or the result is that the south pole of the first permanent magnet and the north pole of the second permanent magnet face the transducer, while the north pole of the first permanent magnet and the south pole of the second permanent magnet face away from the transducer.

In one particularly flexible design of the swivel angle measuring device according to the disclosure, the transducer can detect all possible movement directions of the permanent magnets in an adjacent plane of motion. This transducer is also known as a 3D sensor.

The transducer has an electronic sensor component that is stationary and affixed to the housing adjacent to the translationally moved permanent magnets. The sensor component has a longitudinal axis defining a major axis of the transducer. When using the above-mentioned 3D sensor, this main axis can therefore be arranged transversely or longitudinally to the movement direction of the adjustment piston. However, this main axis of the transducer can also assume any angle deviating from the movement direction of the adjustment piston when using the above-mentioned 3D sensor.

An air gap is provided between the permanent magnets and the pickup. Preferably, a gap is also provided between the permanent magnets. In the case of the two permanent magnets, a ratio of the air gap to the distance between the two permanent magnets is preferably between 0.295 and 0.558, in particular 0.426. For example, in a specific application, the air gap can be 4.35 mm, while the distance between the two permanent magnets is 10.2 mm.

The disclosed hydrostatic axial piston machine has a swashplate or inclined axis design, and therefore has a swashplate or cylinder drum, the swivel angle of which can be adjusted by means of an adjustment piston guided in an adjustment cylinder. A swivel angle measuring device as described above is operatively connected to the adjustment piston.

In a particularly preferred further development, the adjustment cylinder is a differential cylinder, wherein the adjustment piston has a piston rod to which a transverse pin is attached. The permanent magnets are then attached directly or indirectly to the end portion of the piston rod that is opposite the adjustment piston. This end portion is movable in a measuring housing in which the pick-up is inserted (e.g. in a through recess).

A particularly large amount of installation length in the movement direction of the adjustment piston is saved if a housing-fixed spring system of the return spring (viewed in the movement direction of the adjustment piston) is arranged directly adjacent to the transducer and/or to the through recess of the measuring housing.

According to a first attachment concept, the permanent magnets are attached indirectly via a carrier component to an end portion of the piston rod, which extends along the movement direction.

The carrier component can be U-shaped when viewed in a sectional plane arranged transverse to the movement direction of the adjustment piston. The carrier component can be a bent sheet metal part. The carrier component may be a sheet metal bent part.

The carrier component can be attached to the end portion or a trough-shaped recess in the end portion by means of a screw and two centering pins or centering bushes.

The permanent magnets are preferably accommodated in a magnet housing. The magnet housing can be attached to the carrier component by means of a screw pin preferably cast into the magnet housing and, for example, two centering pins cast integrally onto the magnet housing.

According to a second fastening concept, a flattened portion is formed on an end portion of the piston rod, which extends parallel to the movement direction and which is formed by a milled or chamfered portion. The permanent magnets are then attached to the flattened portion of the piston rod.

In the second attachment concept, it is also preferred if the permanent magnets are accommodated in a magnet housing, which is attached to the flattened portion and thus to the end portion of the piston rod, for example by means of a screw connection and two centering pins.

### BRIEF DESCRIPTION OF THE DRAWINGS

Principles and exemplary embodiments of the present disclosure will be described in the following on the basis of the accompanying figures.

FIG. 1 shows the exemplary embodiment of the axial piston machine according to the disclosure with a swivel angle measuring device according to the disclosure;

FIG. 2 shows an excerpt of the axial piston machine of FIG. 1 with the swivel angle measuring device of FIG. 1;

FIG. 3 shows an excerpt of the axial piston machine of FIG. 1 with a second exemplary embodiment of the swivel angle measuring device according to the disclosure;

FIG. 4 shows an excerpt of the axial piston machine of FIG. 1 with a third exemplary embodiment of the swivel angle measuring device according to the disclosure;

FIG. 5 shows a fourth exemplary embodiment of the swivel angle measuring device according to the disclosure;

FIG. 6 shows a fifth exemplary embodiment of the swivel angle measuring device according to the disclosure;

FIG. 7 shows a sixth exemplary embodiment of the swivel angle measuring device according to the disclosure.

FIG. 8 shows a section of the swivel angle measuring devices of the various exemplary embodiments according to FIGS. 1 to 7;

FIG. 9 shows an excerpt of the axial piston machine of FIG. 1 with a seventh exemplary embodiment of the swivel angle measuring device according to the disclosure; and

FIG. 10 shows a section of the swivel angle measuring device from FIG. 9.

### DETAILED DESCRIPTION

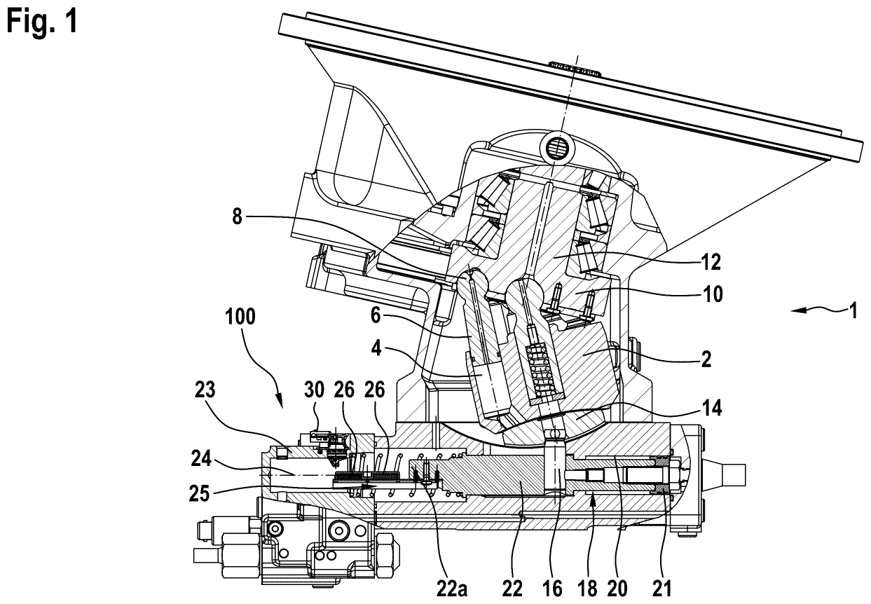

FIG. 1 shows an exemplary embodiment of the axial piston machine 1 according to the disclosure in a longitudinal section. It has a circumferential cylinder drum 2 at the circumference of which a plurality of cylinders 4 are formed, in each of which a piston 6 is arranged, respectively. Piston feet 8 of pistons 6 are flexibly coupled to a flange 10 of a drive shaft 12. According to the design principle of the inclined axle machine, a center axis of the cylinder drum 2 is inclined towards a center axis of the drive shaft 12.

In order to be able to change the inclined positions of the two center axes with respect to each other and thus the swivel angle of the cylinder drum 2, the latter has a concave abutment surface that is tensioned against a corresponding convex abutment surface of a control lens 14. Centrally engaged with the control lens 14 is a transverse pin 16 radially inserted into an adjustment piston 18. The adjustment piston 18 is guided in an adjustment cylinder 20 of an adjustment device along a movement direction 24. The adjustment cylinder 20 is embodied as a double acting differential cylinder. Accordingly, the adjustment piston 18 is composed of a piston section 21 and a piston rod 22, from which the transverse pin 16 projects radially towards the control lens 14.

A center axis 24 of the piston rod 22 and thus also of adjustment cylinder 20 defines the movement direction 24, wherein in FIG. 1, a movement to the left corresponds to a reduction of the swivel angle and thus a reduction of the stroke volume of axial piston machine 1, while a movement to the right corresponds to an increase of the swivel angle and thus an increase of the stroke volume of the axial piston machine 1.

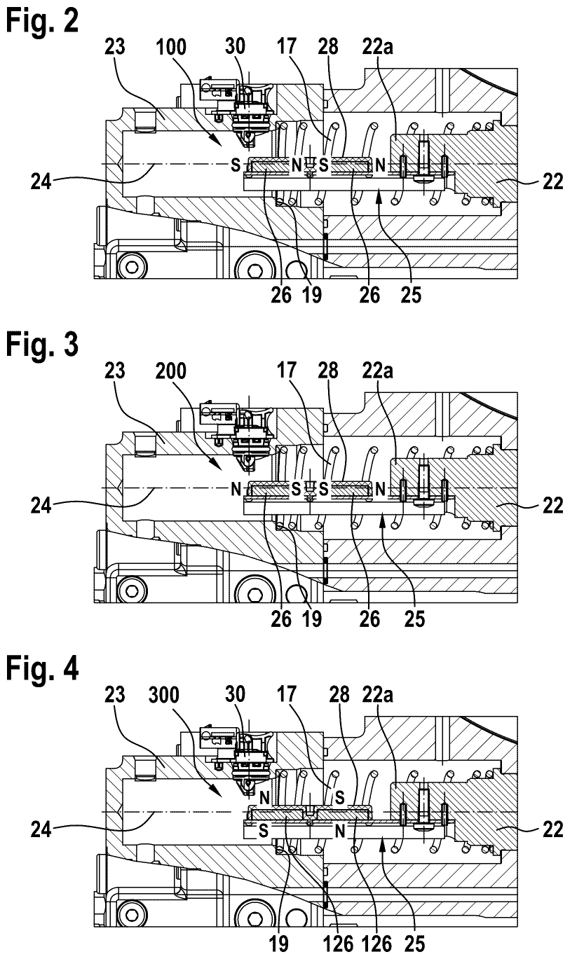

In FIG. 1, the adjustment piston 18 is shown in an end position (on the right in FIG. 1), into which the adjustment piston 18 is clamped by a return spring 17, which is shown more clearly in FIGS. 2 to 4.

A first exemplary embodiment of the swivel angle measuring device 100 according to the disclosure is disposed on a free end portion 22a of the piston rod 22. It has a U-shaped carrier component 25 made of sheet metal, which extends into a measuring housing 23 parallel to the center axis 24. The carrier component 25 is fixed to the free end portion 22a of the piston rod 22 by means of two pins and a screw. It carries two rod-shaped permanent magnets 26. More specifically, the two permanent magnets 26 are inserted or injected into a trough-like magnetic housing 28, which is attached to a central base side of the U-shaped carrier component 25. Two legs, of which only one leg is shown in FIG. 1 due to the section, extend (in FIG. 1 downwards) away from the permanent magnets 26 and their magnetic housing 28.

As already stated, the carrier component 25 extends with the magnetic housing 28 attached thereto and the two permanent magnets 26 mounted therein into the stationary measuring housing 23. At the maximum swivel angle of the axial piston machine 1 shown in FIG. 1, only the first permanent magnet 26 and a part of the second permanent magnet 26 are disposed in this measuring housing 23. At a minimum swivel angle, both permanent magnets 26 are disposed entirely in this measuring housing 23.

In a through-hole recess of the stationary measuring housing 23, a transducer 30, configured as a Hall sensor, is arranged, having a socket which is accessible on the outer side of the measuring housing 23.

FIGS. 2 to 4 each show the same section of the measuring housing 23 with three different exemplary embodiments of the swivel angle measuring device 100; 200; 300 according to the disclosure.

An electronic sensor component, which is housed in this end portion of the transducer 30 and is therefore not visible, is mounted in an end portion of the transducer 30 facing the permanent magnet 26 (shown as lower in FIGS. 2 to 4) and projecting into the measuring housing 23. In the exemplary embodiments shown in FIGS. 2 to 4, the axis of this sensor component and thus also a major axis 30b of the end portion of the transducer 30 are arranged perpendicular to the drawing plane and thus transversely to the movement direction 24 of the adjustment piston 18.

In the exemplary embodiment according to FIGS. 1 and 2, the rod-shaped permanent magnets 26 are disposed such that first a south pole S of the first permanent magnet 26, then its north pole N, then the south pole S of the second permanent magnet 26 and finally its north pole N are arranged along the movement direction 24. A four-pole arrangement is thus formed from the two permanent magnets 26.

In the exemplary embodiment according to FIG. 3, the two rod-shaped permanent magnets 26 are arranged such that first a north pole N of the first permanent magnet 26, then its south pole S, then the south pole S of the second permanent magnet 26 and finally its north pole N are arranged along the movement direction 24. A three-pole arrangement is thus formed from the two permanent magnets 26.

In the exemplary embodiment according to FIG. 4, the permanent magnets 126 are configured such that they have the two poles N, S on their long opposing sides. The first permanent magnet 126 has its north pole N on the side facing the transducer 30, while its south pole S faces the carrier component 25. Conversely, the second permanent magnet 126 has its south pole S on the side facing the transducer 30, while its north pole N faces the carrier component 25.

In FIGS. 2 to 4, the piston rod 22 of the adjustment piston 18 is shown in an end position (maximum right), into which the adjustment piston 18 is clamped by the return spring 17. In this end position, the free end portion 22a of the piston rod 22 and a large part of the carrier component 25 are arranged inside the return spring 17. Furthermore, in the end position inside the return spring 17, the permanent magnet 26 close to the end portion 22a (on the right in FIGS. 2 to 4) is completely arranged and the permanent magnet 26 remote from the end portion 22a (on the left in FIGS. 2 to 4) is partially arranged.

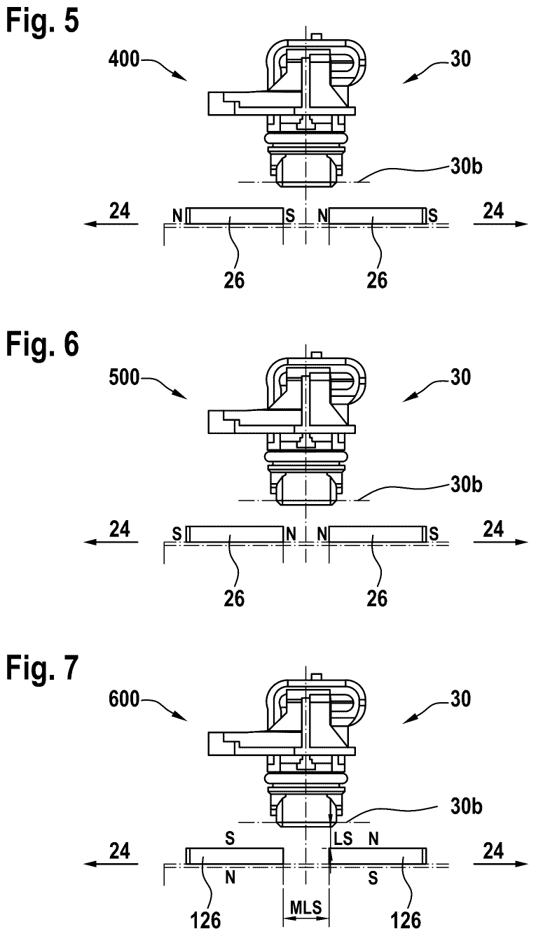

FIGS. 5 to 7 show a further exemplary embodiment of the swivel angle measuring device 200; 300; 400 according to the disclosure.

As already stated with reference to FIGS. 1 to 4, an electronic sensor component is mounted in the end portion of the transducer 30 facing the permanent magnet 26 (shown as lower in FIGS. 5 to 7). The axis of this sensor component and thus also the major axis 30b of the end portion of the transducer 30 is arranged parallel to the drawing plane and thus parallel to the movement direction 24 in the exemplary embodiments shown in FIGS. 5 to 7.

In the exemplary embodiment according to FIG. 5, the rod-shaped permanent magnets 26 are arranged such that first a south pole S of the first permanent magnet 26, then its north pole N, then the south pole S of the second permanent magnet 26 and finally its north pole N are arranged along the movement direction 24. A four-pole arrangement is thus formed from the two permanent magnets 26.

In the exemplary embodiment according to FIG. 6, the rod-shaped permanent magnets 26 are arranged such that first a north pole N of the first permanent magnet 26, then its south pole S, then the south pole S of the second permanent magnet 26 and finally its north pole N are arranged along the movement direction 24. A three-pole arrangement is thus formed from the two permanent magnets 26.

In the exemplary embodiment according to FIG. 7, the permanent magnets 126 are configured such that they have the two poles N, S on their long opposing sides. The first permanent magnet 126 has its south pole S on the side facing the transducer 30, while its north pole N faces the carrier component 25. Conversely, the second permanent magnet 126 has its north pole N on the side facing the transducer 30, while its south pole S faces the carrier component 25.

The distance MLS between the two permanent magnets 26 may be 10.2 mm. The air gap AG between the end portion of the transducer 30 configured as a Hall sensor and the permanent magnet 26 may be 4.35 mm+/−1.34 mm.

The two permanent magnets 26; 126 may be spaced apart from one another and the transducer 30 arranged such that the detectable range of motion of the adjustment piston 18 is 60 mm.

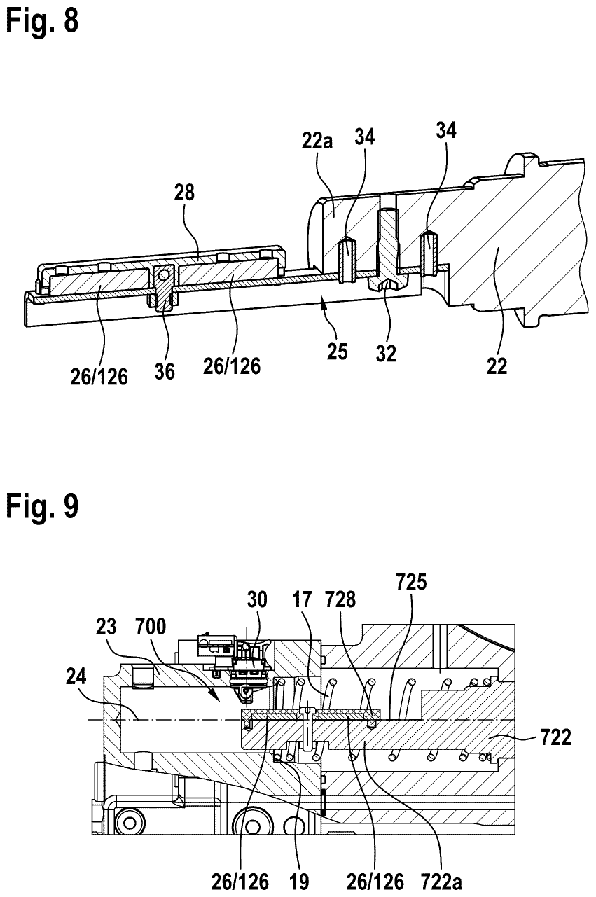

FIG. 8 shows a section of the swivel angle measuring device of the various exemplary embodiments according to FIGS. 1 to 7. The illustration comprises all the different embodiments and orientations of the permanent magnets 26; 126 according to FIGS. 1 to 7.

FIG. 8 illustrates that the carrier component 25 has a central base side and two legs, wherein only half of the base side and one of the two legs can be seen in FIG. 8. The carrier component 25 is attached on one side to the end portion 22a of the piston rod 22 by means of a screw 32. The screw 32 is inserted through a through recess of the base side of the carrier component 25 and screwed into a threaded hole of the end portion 22a.

The carrier component 25 is aligned along the movement direction 24 (see FIGS. 1 to 7) by means of two centering bushes 34, which are inserted along the movement direction 24 in front of and behind the screw 32, on the one hand, in through recesses of the base side of the carrier component 25 and, on the other hand, in blind holes of the end portion 22a of the piston rod 22.

The magnet housing 28 has two trough-like recesses for the two permanent magnets 26; 126, between which a web is arranged into which a screw pin 36 is cast. This screw pin 36 is inserted through a through recess in the base side of the carrier component 25 and screwed on with a nut.

The nut of the screw pin 36 and the screw head of the screw 32 are accommodated in the interior of the cross-sectionally U-shaped carrier component 25 so as not to catch on the return spring 17 (see FIGS. 2 to 4).

FIG. 9 shows a section of the axial piston machine 1 of FIG. 1 with a seventh exemplary embodiment of the swivel angle measuring device 700 according to the disclosure. The swivel angle measuring device 700 has a flattened portion 725 at the end portion 722a of the piston rod 722, which extends parallel to the movement direction 24 (see FIG. 1), and which is produced by milling off approximately half of the cross-section of the end portion 722a of the piston rod 722.

In FIG. 9, the piston rod 722 of the adjustment piston 18 is shown in the end position (maximum right), into which the adjustment piston 18 is tensioned by the maximally relaxed return spring 17. In this end position, the free end portion 722a of the piston rod 722 and a large part of the flattened portion 725 are arranged inside the return spring 17. Furthermore, in the end position, the permanent magnet 26; 126 close to the end portion 722a (on the right in FIG. 9) is completely arranged inside the return spring 17 and the permanent magnet 26; 126 remote from the end portion 722a (on the left in FIG. 9) is partially arranged.

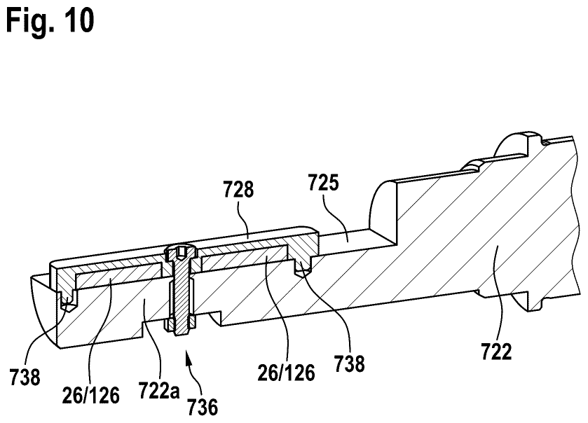

FIG. 10 shows a section of the swivel angle measuring device 700 of FIG. 9. It can be seen that a magnet housing 28 is attached to the flattened portion 725, which carries the two permanent magnets 26; 126. For this purpose, the magnet housing 28 has two trough-like recesses for the two permanent magnets 26; 126, between which a web is arranged. A screw of a screw connection 736, the nut of which is arranged on the outer circumference of the end portion 722a of the piston rod 722, is inserted in a through recess of the web. More precisely, the nut is received in a recess on the outer circumference of the end portion 722a so as not to catch on the return spring 17 (see FIG. 9).

At the two end portions of the magnet housing 28, which are spaced apart in the movement direction 24, respective centering pins 738 are cast on, which extend into corresponding blind holes in the flattened portion 725.

FIGS. 2 to 4 and FIG. 9 show that a spring system 19 for the return spring 17, which is fixed to the housing and formed by a radial shoulder, is arranged on an inner wall of the measuring housing 23. This spring system 19 is arranged in the immediate vicinity of the recess of the transducer 30. As a result, the overall length of the swivel angle measuring devices 100; 200; 300; 400; 500; 600 700 along the movement direction 24 is minimized.

In FIG. 1 and in FIGS. 2 to 4 and in FIG. 9, the arrangement of the transducer 30 relative to the two permanent magnets 26 is shown rotated by 90° with respect to FIGS. 5 to 7. The spatial installation position between the transducer 30 and the permanent magnets 26 can be arbitrary as long as the permanent magnets 26 perform a recurring defined movement along their movement direction 24 (center axis 24) relative to the main axis 30b of the transducer 30.

### LIST OF REFERENCE NUMBERS

1 Axial piston machine
2 Cylinder drum
4 Cylinder
6 Piston
8 Piston foot
10 Flange
12 Drive shaft
14 Control lens
16 Transverse pin
17 Return spring
18 Adjustment piston
19 Spring system
20 Adjustment cylinder
21 Piston section
22; 722 Piston rod
22a; 722a Free end portion
23 Measuring housing
24 Center axis/movement direction
25 Carrier component
26 Permanent magnet
28; 728 Magnet housing
30 Transducer
30b Major axis
32 Screw
34 Centering bush
36 Screw pin
100 Swivel angle measuring device
126 Permanent magnet
200 Swivel angle measuring device
300 Swivel angle measuring device
400 Swivel angle measuring device
500 Swivel angle measuring device
600 Swivel angle measuring device
700 Swivel angle measuring device
725 Flattened portion
736 Screw connection
738 Centering pins
AG Air gap
MLS Distance

1. A swivel angle measuring device designed and configured for indirectly sensing a swivel angle of a swashplate or cylinder drum of a hydrostatic axial piston machine, the swivel angle being adjustable by an adjustment piston guided in an adjustment cylinder, the swivel angle measuring device comprising:
a movable encoder having two permanent magnets configured to be carried linearly and translationally by the adjustment piston along a movement direction of the adjustment piston, the two permanent magnets being separated from one another by a distance; and
a transducer affixed to a housing of the hydrostatic axial piston machine,
wherein the swivel angle measuring device is translational, and
wherein, in an end position of the adjustment piston, at least one of the two permanent magnets is arranged at least in sections inside a return spring of the adjustment piston.

2. The swivel angle measuring device according to claim 1, wherein, in the end position of the adjustment piston, one of the two permanent magnets is arranged completely inside the return spring.

3. The swivel angle measuring device according to claim 1, wherein, in the end position of the adjustment piston, one of the two permanent magnets is arranged completely inside the return spring, while the other of the two permanent magnets is arranged in sections inside the return spring.

4. The swivel angle measuring device according to claim 1, wherein north poles and south poles of the permanent magnets are arranged in alternating order along the movement direction of the adjustment piston, or wherein either respective north poles (N) or respective south poles of the permanent magnets are assigned to one another along the movement direction of the adjustment piston.

5. The swivel angle measuring device according to claim 1, wherein each permanent magnet of the two permanent magnets has a main axis extending through a south pole and through a north pole, and main axes of the permanent magnets are arranged perpendicular to the movement direction of the adjustment piston.

6. The swivel angle measuring device according to claim 1, wherein the transducer is configured to detect all possible movement directions of the two permanent magnets in a plane of movement.

7. The swivel angle measuring device according to claim 6, wherein the transducer has an electronic sensor component which has a longitudinal axis defining a main axis of the transducer, and the main axis of the transducer is arranged transversely or longitudinally to the movement direction of the adjustment piston.

8. A hydrostatic axial piston machine of a swashplate or inclined axle design, comprising:
a swashplate or cylinder drum having a swivel angle that is adjustable by an adjustment piston guided in an adjustment cylinder; and
a swivel angle measuring device configured to indirectly sense the swivel angle, the swivel angle measuring device comprising:
a movable encoder having two permanent magnets configured to be carried linearly and translationally by the adjustment piston along a movement direction of the adjustment piston, the two permanent magnets being separated from one another by a distance; and
a transducer affixed to a housing of the hydrostatic axial piston machine,
wherein the swivel angle measuring device is translational, and
wherein, in an end position of the adjustment piston, at least one of the two permanent magnets is arranged at least in sections inside a return spring of the adjustment piston.

9. The hydrostatic axial piston machine according to claim 8, wherein:
the adjustment cylinder is a differential cylinder,
the adjustment piston has a piston rod to which a transverse pin is attached,
the two permanent magnets are attached indirectly via a carrier component to an end portion of the piston rod, and
the carrier component extends along the movement direction.

10. The hydrostatic axial piston machine according to claim 9, wherein the carrier component is attached to the end portion by a screw and two centering pins or centering bushes.

11. The hydrostatic axial piston machine according to claim 9, wherein the permanent magnets are accommodated in a magnet housing, which is attached to the carrier component by a screw pin cast into the magnet housing and by two centering pins.

12. The hydrostatic axial piston machine according to claim 8, wherein:
the adjustment cylinder is a differential cylinder,
the adjustment piston has a piston rod to which a transverse pin is attached,
a flattened portion is formed at an end portion of the piston rod, the flattened portion extending parallel to the movement direction, and
the two permanent magnets are attached to the flattened portion.

13. The hydrostatic axial piston machine according to claim 12, wherein the permanent magnets are accommodated in a magnet housing, which is attached to at least one of the end portion and the flattened portion by a screw connection and two centering pins.
